(19) United States
(12) Patent Application Publication
(10) Pub. No.: US 2003/0165592 A1
(43) Pub. Date: Sep. 4, 2003

(54) Effective use of protease in winemaking

(76) Inventors: Daqing Sun, South Bend, IN (US); Jack N. Harris, Granger, IN (US)

Correspondence Address: BAKER & DANIELS, 205 W. JEFFERSON BOULEVARD, SUITE 250, SOUTH BEND, IN, 46601, US

(21) Appl. No.: 10/085,323

(22) Filed: Feb. 28, 2002

(51) Int. Cl. C12G 1/00

(52) U.S. Cl. 426/12

(57) ABSTRACT

A method of making wine which involves the use of a protease to eliminate heat-unstable proteins, which cause heat-induced haze or precipitate. The protease can be used at any stage of the wine making process, but it is more advantageous to used the protease at the beginning of fermentation before the generation of inhibitive factors. A wine treated with a protease under this condition can replace a substantial amount of bentonite that is normally required for heat stabilization of the wine. By hydrolyzing the fruit protein, protease can be used as an anti-foam agent in fruit juices and during fermentation of fruit juices.

### TECHNICAL FIELD

The present invention relates to winemaking. More particularly, the present invention relates to the use of protease in winemaking to reduce or eliminate heat-induced protein haze or precipitate and to control foaming.

### BACKGROUND ART

The formation of haze or precipitate in wine after it is bottled causes consumers to be suspicious as to the quality of the wine. For consumers, the formation of haze or precipitates in wine indicates that the wine may be of poor quality or microbiologically spoiled, regardless how the wine may actually taste.

The most common cause of haze or precipitates forming in wine can be attributed to the instability of wine proteins, when the wine is exposed to high temperatures. This phenomenon is referred to as heat-induced protein haze or precipitate.

The wine industry has spent an enormous amount of time and effort trying provide a practical solution to the problem of heat-induced protein haze or precipitate. For the most part, solutions have focused on providing ways to remove the heat-unstable wine proteins before bottling wine. Absent an acceptable method to remove the heat-unstable wine proteins, the wine industry continues to suffer economic loses.

One commonly known and accepted method for removing heat-unstable wine proteins from wine involves the use of bentonite to adsorb the heat-unstable proteins. However, winemakers are often reluctant to use bentonite, because, in addition to absorbing heat-unstable proteins, bentonite also adsorbs many desirable wine flavor components and other components from wine the loss of which results in an overall reduction in wine quality. Hoj et al., “The ‘Haze Proteins’ of Wine—A Summary of Properties, Factors Affecting Their Accumulation in Grapes, and the Amount of Bentonite Required for Their Removal from Wine,” (Proceedings of the ASEV 50th anniversary annual meeting, Jun. 19-23, 2000), and Hsu et al., “Heat-unstable Proteins in Wine. I Characterization and Removal by Bentonite Fining and Heat Treatment,” (Am. J. Enol. Vitic. 38:11-16, 1987), discuss proposed methods to remove heat-unstable proteins from wine.

Bentonite is an impure hydrated aluminum silicate clay that is added to wine as a suspension in a process called ‘fining’. Wine is “fined” by adding a fining agent thereto, which fining agent chemically and/or physically binds to and flocculate substances which cause the wine to cloud.

Bentonite is commonly used together with gelatin as a co-fining agent. Other fining materials/agents include casein, egg albumin, isinglass, and colloidal silica. These materials/agents have been used with varying degrees of effectiveness. Ion exchange resins, which are not considered to be fining agents, have also been used to adsorb wine proteins. Like bentonite, the use of ion exchange resins is not particularly desirable, because ion exchange resins absorb both desirable and undesirable wine components indiscriminately.

Bentonite adsorbs proteins primarily by electrostatic attraction, and to a lesser extent, by hydrogen-bonding. Advantages for using bentonite include its effectiveness in protein adsorption and low cost. However, overall, the disadvantages noted above out-weight the advantages. Other undesirable characteristics associated with the use of bentonite are that:

(1) Bentonite retains large volumes of wine, resulting in a significant loss in wine volume that is very difficult to recover. Hoj et al. (Proceedings of the ASEV 50th anniversary annual meeting, Jun. 19-23, 2000) reports an estimated wine volume loss of 5-10% when bentonite is used. This amount of loss becomes significant considering that it translates into an annual loss of $100-166 million for each percentage of loss based on worldwide wine production.

(2) Bentonite particles are very small and therefore bentonites can clog wine filters quickly. The resulting short filtration cycles effect an excessive handling of the wine, which causes a lowering in the quality of the wine and an increase in wine loss.

(3) Bentonite is known to contain about 10 wt % sandy particles, which are quite abrasive to pumps, stainless steel wine lines and tanks, and other wine processing equipment.

(4) Disposing of used bentonite presents environmental problems. In this regard, bentonite retains large amounts of grape and wine organic matters, and therefore, it has a high biological oxygen demand (BOD). Because bentonite has a very small particle size, when it is disposed of by land discharge, it tends to load in the soil, making the discharge area impermeable to the water. When standing water accumulates, organic matters in the standing water putrefy quickly and generate foul odors.

Because of the above disadvantages, it is easy to understand why winemakers are interested in avoiding the use of bentonite.

Other methods that have shown limited success in removing heat-unstable proteins from wine include ultra-filtration using polymeric membranes, flash pasteurization, and addition of proteolytic enzymes. Although attractive in principle, a number of authors, for example, Hoj et al. (Proceedings of the ASEV 50th anniversary annual meeting, Jun. 19-23, 2000) have stated that the use of proteolytic enzymes has proven to be ineffective “under the standard winemaking conditions.”

Only “under the standard winemaking conditions” can the winemakers produce quality wines acceptable to consumers. Standard winemaking conditions are generally defined as the parameters and procedures associated with the steps of crushing grapes to extract their juices, adding yeast to ferment the grape juice by converting grape sugar to alcohol, and then removing the grape/wine solids by fining, e.g. with gelatin and bentonite, and gravity settling, or by centrifugation and filtration.

Fermentation is usually carried out in at natural grape pH of 3.0-3.5, and at an ambient temperature of 13-28° C. In addition to the steps listed above which are the standard or basis steps, a second addition of gelatin and bentonite can be used to remove wine protein in order to render the wine “heat-stable”. The wine can also be cooled to 0° C. or less for a sufficient period of time that will allow most of the potassium and tartrate ions to precipitate out and thereby render the wine “cold stable”. Both heat and cold stability can be carried out simultaneously, before or after blending with different varieties of grapes, depending on the type of wine.

As noted above, limited success in removing heat-unstable proteins from wine has been achieved by the use of proteolytic enzymes. It is generally recognized that proteolytic enzymes, also called proteases, peptidases or polypeptidases, are the best choice of methods, because of their specificity towards wine proteins. Also, because of their catalytic mechanism, only a small amount of these enzymes is required to eliminate proteins in wine under the natural pH of the fruit. Ideally, the use of these enzymes results in no loss of wine volume, flavor, or other desirable components. Unfortunately, in spite of a large amount of research work done in this area, the use of protease has not been successful due to the following major obstacles:

(1) Proteolytic enzymes are not highly active in wine due to unknown inhibitory factors as reported by Modra et al. (“Are Proteases Active in Wines and Juices?”, The Aust. Grapegrower & Winemaker. Page 42-46. April, 1988.)

(2) Proteolytic enzymes (and all other enzymes) are proteins, which may cause haze or precipitation under the same high temperature conditions as the wine/grape proteins.

(3) Proteins of certain grape varieties are resistant to proteolytic enzymes as reported by Water et al. (“The identification of heat-unstable proteins and their resistance to peptidases,” J. Agric. Food Chem. 40:1514-1519, 1992.)

(4) If a proteolytic enzyme is added after a wine is made, the cold storage temperature will decrease the enzyme activity.

Although the amount of heat-unstable proteins are not large in grapes, (most varieties contain between 50-100 mg/L) the formation of voluminous, cotton-like flocculent or precipitate under high temperature, e.g. over 30° C., during storage or shipping can be quite objectionable to consumers. It is pointed out that while not all the grape/wine proteins are heat-unstable, proteins having a molecular weight between 10,000-30,000 Dalton are the most heat-unstable.

Fungal protease has been found to be able to increase ethanol content and increase the rate of ethanol production in fermentation of sugars derived from corn starch as disclosed in U.S. Pat. No. 5,231,017 to Lantero et al. Fungal protease has also been found to decrease the gushing tendency in bottled beer after one to three months of storage as disclosed in U.S. Pat. No. 4,181,742 to Horiuchi et al. In addition, Fungal protease has also been found to prevent haze formation in beer under cold temperatures of 0° C. or less (chillproof of beer) as disclosed in U.S. Pat. No. 3,740,233 to Nelson et al.

To date there is no report on using protease from fungi or proteases from other sources successfully to remove heat-unstable protein for the purpose of preventing heat-induced haze or precipitate in winemaking.

Grape proteins are important in the foaming ability of certain wines, such as champagnes. The majority of these proteins have a molecular size of 20,000-30,000 Dalton. However, foaming during fermentation or foam formation during certain common process steps such as product transfer by pumping can be a problem in non-champagne wines that are not produced under pressure. Foaming during fermentation reduces fermenter capacity, results in lose of valuable wine in instances of foam-over, creates sanitary problems in the winemaking process, and can result in the introduction of microbial contamination into the wine.

The current practice in the winemaking industry is to use chemical anti-foaming agents such as those made from silicone. Chemical anti-foaming agents are applied to the surface of foam whenever is needed to keep the foam from overflowing. There is however a prescribed regulated limit to the amount of anti-foaming agents that can be added to wine. In practice, it is quite easy to exceed the allowed amount of anti-foaming agents when foaming occurs repeatedly during an entire fermentation cycle. Many wines are filtered with membranes made from polymers such as polysulfone, polyamide and polyvinylidene fluoride. The use of conventional silicone anti-foaming agents clog polymer membrane filters quite easily.

### DISCLOSURE OF THE INVENTION

According to various features, characteristics and embodiments of the present invention which will become apparent as the description thereof proceeds, the present invention provides a method of rendering wine heat-stable which involves:

adding to wine, prior to bottling, a protease that will hydrolyze proteins that cause heat-induced protein haze or precipitate.

The present invention further provides a method of producing an alcohol beverage which involves the steps of:

a) providing a fermentable fruit material;

b) fermenting the fermentable fruit material under conditions sufficient to produce an alcohol beverage; and

c) adding protease to at least one of the fermentable fruit material before or during fermentation and the alcohol beverage after fermentation to hydrolyze proteins that cause heat-induced protein haze or precipitate.

The present invention also provides a method of controlling foaming in a fermentation process which involves the steps of:

a) providing a fermentable material;

b) fermenting the fermentable material under conditions sufficient to normally produce foam; and

c) adding protease to the fermentable material before fermentation to control the production of foam.

The present invention further provides a method of making wine which involves the steps of:

a) providing a fermentable fruit material;

b) fermenting the fermentable fruit material under conditions sufficient to produce an alcohol beverage;

c) removing solids from the fermented fermentable material; and

d) adding protease to at least one of the fermentable fruit material before or during fermentation and the alcohol beverage after fermentation to hydrolyze proteins that cause heat-induced protein haze or precipitate.

The present invention still further provides an improvement in winemaking processes which include the use of bentonite to adsorb the heat-unstable proteins, the improvement involving substituting at least a portion of the bentonite with a protease that hydrolyzes the heat-unstable proteins.

The present invention also provides a method of controlling foaming during the processing of a liquid fruit material which involves the steps of:

a) providing a liquid fruit material that is subjected to processing step that normally causes foaming of the liquid fruit material; and

b) adding protease to the fruit material fermentation to control the production of foam during the processing.

### BRIEF DESCRIPTION OF DRAWINGS

The present invention will be described with reference to the attached drawing which are given as non-limiting examples only, in which:

FIG. 1 is a flow diagram which illustrates a wine making process according to one embodiment of the present invention.

FIG. 2 is a flow diagram which illustrates a wine making process according to another embodiment of the present invention.

### BEST MODE FOR CARRYING OUT THE INVENTION

The present invention takes advantage of the inventors' theory that if a protease could reduce or eliminate wine proteins having a molecular weight between 10,000-30,000 Dalton under the normal wine pH of 3.0-3.5, the protease could eliminate or reduce the amount of heat-unstable proteins, rendering the resulting wine heat-stable without the conventional use of bentonite.

In pursuing and testing their theory, the present inventors have also unexpectedly discovered that in addition to reducing the amount of heat-unstable proteins, proteolytic enzymes also hydrolyze or remove foarm-forming proteins, thus solving foaming problems. This feature of the present invention which is discussed in more detail below is easily adapted to control foam problems not only in wine fermentations, but also in other types of fermentation such as those used to produce enzymes, food and feed ingredients, food supplements including vitamins, pharmaceuticals such as antibiotics and antimycotics and other bio-active ingredients, without the use of chemical anti-foaming agents.

The present invention involves adding a protease to winemaking processes to reduce or eliminate heat-induced protein haze or precipitate and to control foaming. The protease has been found to reduce or eliminate proteins that can cause heat-induced haze or precipitate. The protease functions to hydrolyze and thereby remove or eliminate these proteins. Unexpectedly, it was discovered that the protease also reduces or eliminates proteins that cause foaming in winemaking processes.

As discussed in more detail below, the protease can be added at various stages in a wine making process, with certain advantages obtained when added at particular stages.

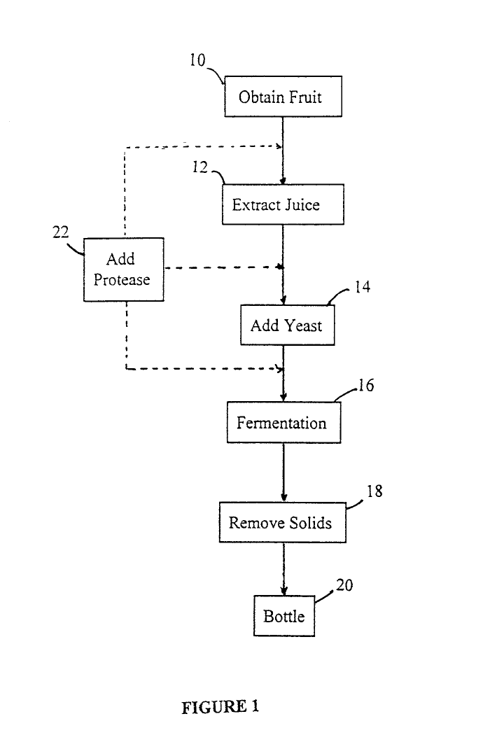

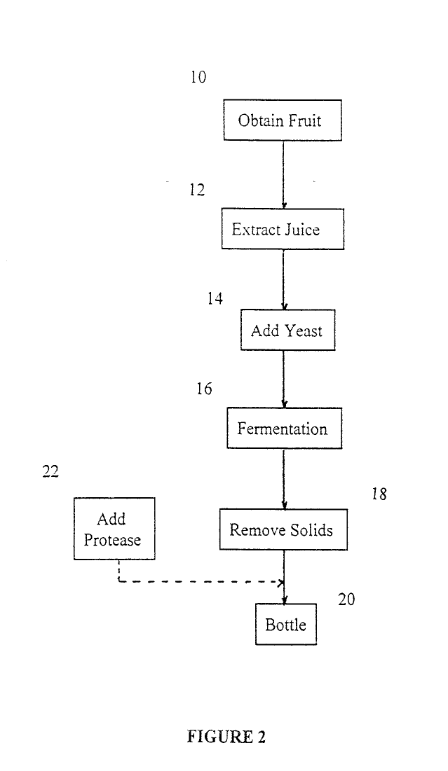

FIG. 1 is a flow diagram which illustrates a winemaking process according to one embodiment of the present invention. FIG. 2 is a flow diagram which illustrates a winemaking process according to another embodiment of the present invention. Common reference numbers are used in the figures to identify common method steps.

The winemaking processes in each of FIGS. 1 and 2 begin with a step 10 of obtaining fruit. As discussed below, various fruits can be used including, but not limited to grapes, apples, pineapples, peaches, pears, oranges, grapefruit, and various types of berries such as raspberries, cranberries, strawberries, etc. In order to be suitable for fermentation, the fruit or juice obtained therefrom should have a pH within the range of from about 2.5 to about 4.0 and a fermentable sugar content which could be in the range of from 8 wt % to about 25 wt %.

The juice is extracted from the fruit in step 12 by conventional crushing methods. At this point pectin and/or polysaccharides can be removed, if desired by adding a pectic enzyme and/or arabanase.

Yeast is added in step 14. Pulp or other fruit solids can be removed before the yeast is added in step 14. Although there are exceptions, normally pulp is removed from white grape juice before fermentation, and red is fermented in the presence of grape pulp. Fruit solids typically effect the color as well as the flavor of the final beverage. Accordingly, the removal of solids is dependent on the characteristic of the desired final beverage.

After yeast is added, the fruit juice, with or without solids removed is subjected to fermentation in step 16. For grapes, fermentation is usually carried out in the natural grape pH of 3.0-3.5, and at a temperature between about 10° C. to 35° C. with a temperature between 13° C. to 28° C. being often preferred. During fermentation, fermentable sugars are converted into ethanol. At the end of fermentation, the ethanol in wine can be between 2.0 to 16% by volume, depending on the amount of fermentable sugar in juice.

After fermentation, solids are removed in step 18. In FIGS. 1 and 2, step 18 encompasses conventional processes of clarifying, fining, gravity settling and racking, centrifugation and filtration.

The final step in the winemaking processes depicted in FIGS. 1 and 2 is bottling the wine in step 20.

According to the present invention, protease is added to the fruit juice during the winemaking process. FIG. 1 depicts the protease being added at step 22 either before or after fruit pulps are removed in step 12. In this embodiment, the protease is added to remove or eliminate proteins that can cause heat-induced haze or precipitate before or during fermentation in step 16.

FIG. 2 depicts the protease being added at step 22 after solids removal in step 18. In this embodiment, the protease is added to remove or eliminate proteins that can heat-induced haze or precipitate and to control foaming as discussed in detail below.

FIGS. 1 and 2 merely illustrate possible points in a winemaking process at which protease can be added according to the present invention. From the detailed description which follows, it will become apparent that the protease can be added at one or more points in winemaking processes to obtain various advantages according to the present invention.

The source of protease useful for purposes of the present invention can be from microbial sources, plants, and/or animals, provided that the protease has sufficient activity at the fruit pH to eliminate heat-unstable proteins. The pH of natural fruit is in the range from about 2.5 to about 4.0. Exemplary proteases that are active within the normal pH range of fruits include: Fungal proteases from sources such as Aspergillus niger, Aspergillus oryzae, Rhizomucor meihei, and Neosartorya fischeri; yeast proteases from sources such as Candida olea and Saccharomyces cerevisiae; bacterial proteases from Bacillus subtilis, or Bacillus lichenifomis; and animal proteases pepsin and trypsin from bovine or porcine, Of these and others, the protease from Aspergillus niger, var. has been found to be particularly useful for purposes of the present invention, and is used herein to demonstrate the effectiveness of protease in the present invention. Plant proteases ficin from Ficus spp., papain from Carica papaya, bromelain from Ananus comosus or Ananus bracteratus do not exhibit good activity at the acidic pH of fruit, and are therefore not expected to be able to hydrolyze fruit proteins. To verify this assumption, bromelain and/or papain (obtained from Valley Research, Inc., South Bend, Ind.) have been used to compare with the activity of protease from A. niger.

A niger protease, (obtained from Valley Research, Inc., South Bend, Ind.) is used as a non-limiting example of a suitable protease for purposes of the present invention. A. niger protease is active over a pH range from about 2.5 to about 4.0, and at a temperature range of from about 10° C. to about 70° C. As will be discussed below, an effective dosage of the A. niger protease for winemaking according to the present invention is 30-900 mg/L and preferably 120-540 mg/L.

The reference to fruits made herein encompasses any type of fruit or fruit juice, provided the fruit or fruit juice has a natural pH within the range of from about 2.5 to about 4.0, and preferably 2.5 to 3.5, or provided that the pH of the fruit or fruit juice can be adjusted to within this range by adding thereto either an acid or a base. In addition, the fruit or fruit juice used according to the present invention must have a fermentable sugar content which could be in the range of from 8 wt % to about 25 wt %. Also, the fruit or fruit juice used according to the present invention must have a sufficient amount of heat-unstable protein as a substrate for the protease. Examples of fruit include, but not limited to, grapes, apples, pineapples, peaches, pears, oranges, grapefruit, and various types of berries such as raspberries, cranberries, strawberries, etc. In the exemplary embodiments of the present invention grapes and grape juice are presented for illustrative purposes.

The protease can be added to the fruit during or after mashing, with or without removal of the pulp or other fruit solids. Although there are exceptions, normally pulp is removed from white grape juice before fermentation, whereas red grape juice is fermented in the presence of grape pulp.

In one embodiment of the present invention, after extraction of juice from fruit, 25-150 mg sulfur dioxide and 30-900 mg protease are added per liter juice, followed by 0. 1-2.0 gm of hydrated yeast. In a more specific embodiment, the amount of sulfur dioxide added is 50 mg/L, and the amount of protease is 180-540 mg/L. The yeast added is a typical wine yeast such as Montrachet (or any Saccharomyces cerevisiae), which can be purchased from Red Star (Milwaukee, Wis.).

Fermentation is generally carried out at temperatures from about 10° C. to about 35° C., or over a narrower range of from about 13° C. to about 28° C. At the end of fermentation, the ethanol in wine can be between 2.0 to 16% by volume, depending on the amount of fermentable sugar in initial juice. The resulting wine is then clarified using from about 30 to about 120 mg/L gelatin and from about 0.2 to about 3.0 ml per liter colloidal silica. According to a more specific example, from about 40 to about 80 mg/L gelatin and from about 1.0 to about 1.5 ml/L colloidal silica is used to clarify the wine. Colloidal silica is a suspension containing about 30% by weight silica and can be purchased from Hoechst Chemical (Strasbourg, Germany).

Another option that a winemaker can choose is to use a small amount, e.g. from about 60 to about 360 mg/L of bentonite together with gelatin or with gelatin and colloidal silica in amounts described above. Bentonite helps to clarify the wine more efficiently, but has disadvantages as mentioned herein.

The clarified or clear wine is filtered through a layer of diatomaceous earth, followed by filtration using a 0.45 □ membrane. This process renders the wine substantially free from haze particles.

For purposes of testing the wine, after filtration it is subjected to a heat test in which the wine is heated at 60° C. for 15 hours and then is cooled to room temperature, and the amount of heat-induced protein haze or precipitate can be observed and recorded. Other heat tests, under different conditions may also be used.

Some varieties of grapes produce wines that do not show heat precipitation after they are cooled to room temperature. However, they do show the precipitate after they are cooled for six hours at 2-4° C. The results from the heat test under either the room temperature or 2-4° C. method can be judged visually.

For more accurate evaluation of the heat test, some samples can be subject to a protein analysis by sodium dodecyl sulfate-polyacrylamide gel electrophoresis (SDS-PAGE).

The following non-limiting examples illustrate various aspects and features of the present invention. In the examples the reference to protease refers to Aspergillus niger unless otherwise indicated.

### EXAMPLE 1

This example demonstrates that the addition of protease at the fermentation stage of grape juice can effectively remove heat-unstable proteins, resulting in elimination of most of the heat-induced protein haze and precipitate.

In this Example Sauvignon blanc grapes was harvested in Central California in 2000. The grapes were crushed, SO₂ was added to the crushed grapes at 50 mg/L, the mixture was depectinized with a pectic enzyme that did not contain protease, pulp was removed, and the juice was concentrated approximately three fold, from 20° Brix to 68° Brix. The juice concentrate was stored at 2-4° C. This process did not change characteristics of the grape protein. The purpose of preserving the grape juice by these steps was to provide a consistent supply for testing purposes.

A portion of the Sauvignon blanc juice concentrate was reconstituted with tap water to 20° Brix. SO₂ was added in an amount of 50 mg/L to about 2.0 L of the juice. The juice was then divided into four equal samples of about 500 ml each and placed in graduated cylinders. One of the samples was maintained as a control sample and did not have any proteolytic enzyme added thereto. 180 and 540 mg/L of protease was added to two separate samples respectively. 180 mg/L bromelain was added to the fourth sample. 2 gm/L of hydrated Montrachet yeast was added to each of the four samples, followed by fermentation at a temperature of about 21° C.

Foaming in fermenters is normally observed in the first and second days. Little or no foam was observed in the two protease treated samples; whereas both fermenters containing the control and bromelain treated samples developed foam levels of about 30-50% of the fermenting volume. After fermentation, each sample was divided into three equal volumes and treated with the following fining agents:

1-0: No enzyme control and no fining agent.

1-1: No enzyme control and 60 mg gelatin and 1.3 ml colloidal silica per L.

1-2: No enzyme control and 60 mg gelatin, 120 mg bentonite, and 1.3 ml colloidal silica per L.

2-0: 180 mg/L protease and no fining agent.

2-1: 180 mg/L protease with fining agents as in sample/fraction 1-1.

2-2: 180 mg/L protease with fining agents as in sample/fraction 1-2.

3-0: 540 mg/L protease and no fining agent.

3-1: 540 mg/L protease with fining agents as in sample/fraction 1-1.

3-2: 540 mg/L protease with fining agents as in sample/fraction 1-2.

4-0: 180 mg/L bromelain with no fining agents.

4-1: 180 mg/L bromelain with fining agents as in sample/fraction 1-1.

4-2: 180 mg/L bromelain with fining agents as in sample/fraction 1-2.

The samples were subjected to a heat test in which they were heated at 60° C. for 15 hours and then is cooled to 21° C. Table 1 summaries the heat test results of the above samples/fractions.

TABLE 1
Heat test results of Sauvignon blanc wine
made from juice concentrate.

| | Supernatant haziness | Precipitation |
|---|---|---|
| Control, no enzyme | | |
| 1-0 | ++ | +++++ |
| 1-1 | + | ++++ |
| 1-2 | + | ++++ |
| Protease, 180 mg/L | | |
| 2-0 | ++ | -0- |
| 2-1 | ++ | -0- |
| 2-2 | ++ | -0- |
| Protease, 540 mg/L | | |
| 3-0 | ++ | -0- |
| 3-1 | ++ | -0- |
| 3-2 | ++ | -0- |
| . . . Bromelain, 180 mg/L | | |
| 4-0 | + | +++++ |
| 4-1 | + | ++++ |
| 4-2 | + | ++++ |

Note: The amount of haze or precipitate is denoted by number of (+), with maximum of five.

As can be seen from results presented in Table 1, the addition of protease at 180 and 540 mg/L effectively eliminated all of the heat-induced precipitate from grape/wine proteins. It was suspected that the small amount of heat-induced haze might be from enzyme resistant proteins or the enzyme protein itself. However, the improvement is so dramatic that this amount of haze may well be acceptable by winemakers.

As expected for reasons discussed above, the bromelain, a protease of plant origin, was not effective at all.

Adding fining agents at an amount that is considered to have the least effect on wine quality had little or no effect on the reduction of heat-induced haze and precipitate formation.

### EXAMPLE 2

In this Example Chardonnay juice was prepared the same way as the Sauvignon blanc juice in Example 1, except only three samples are prepared and no fining was conducted. The three samples included a sample that contained 540 mg/L protease, a sample that included 540 mg/L papain and a control sample that did not include any enzyme. The samples where subject to a heat test in which they were heated at 60° C. for 15 hours and then is cooled to 4° C.

Chardonnay protein precipitate occurred only after placing the heated samples in a cold room at 4° C. for 6 hours. The results of the heat test are summarized in Table 2.

TABLE 2
Heat test results of Chardonnay wine made from juice concentrate.

| | |
|---|---|
| Supernatant haziness | Precipitation |

| | | |
|---|---|---|
| Control, no enzyme | +++ | +++++ |
| Protease, 540 mg/L | +++++ | -0- |
| Papain, 540 mg/L | +++ | +++++ |

Haze and precipitate formed after placing the samples 6 hours at 4° C.

The results in Table 2 show that the protease sample produced more haze, but no precipitate, than either the control or papain treated samples. This phenomena can be explained by taking into consideration that proteins in different grape varieties will behave differently toward the protease action, and although the protease may have caused the increase in haze, it also clearly eliminated the heat-induced precipitation.

### EXAMPLE 3

This Example demonstrates that protease has the same effectiveness in removing heat-unstable proteins in fresh grapes grown in different regions. In this Example samples of Sauvignon blanc and Muscat of Alexandria grapes were obtained from Central California. In addition, samples of Chardonnay, Sauvignon blanc, and Semillon were obtained from Yakima Valley, Washington. The juice of each sample of grapes was extracted the same way as in Example 1, except the juice was used without being concentrated.

About three liters of juice was obtained to provide the following samples: Samples that contained 540 mg/L protease, samples that contained 540 mg/L papain and control samples that did not include any proteolytic enzyme. Upon completion of fermentation, the filtered wine samples were subjected to a heat test in which they were heated at 60° C. for 15 hours and then cooled to 21° C. (except for Chardonnay which was cooled to 4° C.). The results of the heat tests are presented in Table 3.

TABLE 3
Heat test results of different fresh grape varieties and from
different grape growing regions treated with
proteolytic enzymes.

| | Supernatant haziness | Precipitation |
|---|---|---|
| Sauvignon blanc, Central Calif | | |
| Control, no enzyme | + | +++++ |
| Protease, 540 mg/L | ++ | + |
| Papain, 540 mg/L | + | +++++ |
| Sauvignon blanc, Yakima Valley | | |
| Control, no enzyme | + | +++++ |
| Protease, 540 mg/L | + | + |
| Papain, 540 mg/L | + | ++++ |
| Chardonnay, Yakima Valley | | |
| Control, no enzyme | + | +++++ |
| Protease, 540 mg/L | ++ | + |
| Papain, 540 mg/L | + | +++++ |
| Muscat of Alexandria, | | |
| Central Calif | | |
| Control, no enzyme | ++ | +++++ |
| Protease, 540 mg/L | + | ++ |
| Papain, 540 mg/L | ++ | ++++ |
| Semillon, Yakima Valley, Wash | | |
| Control, no enzyme | ++ | +++ |
| Protease, 540 mg/L | ++ | + |
| Papain, 540 mg/L | ++ | +++ |

As can be seen from the results in Table 3, the protease hydrolyzed heat-unstable proteins to about the same level in all varieties of the grapes, and resulted in a significant reduction of the heat-induced protein precipitate. Many winemakers would find these results acceptable without additional processing to improve them. It was determined that even further reduction of the remaining wine proteins could easily be achieved by using an optimal amount of protease.

It is noted that although there was no taste test conducted with these protease-treated wine samples, it is not difficult to prefer a wine that has never come in contact with a strong absorbent such as bentonite.

The results presented above convincingly show that protease, when used at the beginning of fermentation, can remove the protein successfully, regardless of grape varieties and growing regions.

### EXAMPLE 4

In this Example the heat test results of the preceding Examples were more thoroughly analyzed using SDS-PAGE analysis. Such analysis will demonstrate that removing or reducing certain protein fractions will correspond with the reduction in heat precipitation.

Three wine samples from each of the following grape varieties were used in this study. The test sample included a sample containing 540 mg/L protease, a sample containing 540 mg/L papain and a control sample that did not include any proteolytic enzyme. The samples were not subjected to heat test.

Grape varieties were:

(1) Sauvignon blanc, Washington State

(2) Chardonnay from juice concentrate, Central California,

(3) Muscat, Central California

In the SDS-PAGE analysis, seven protein fractions in the Sauvignon blanc sample were separated, five protein fractions in Chardonnay sample were separated, and seven protein fractions in the Muscat of Alexandria were separated. The molecular weights of these fractions fall within the range of 21,800 to 35,000 Dalton. The results of the SDS-PAGE analysis are summarized in Table 4. In Table 4 the electrophoretic protein bands for each control sample is given a value of 100. Protein bands in enzyme treated samples are expressed as % relative to control sample analysis. Numbers are estimated values.

TABLE 4
SDS-PAGE Results

| | Protein Bands, or estimated molecular weight in daltons | | | | | | | |
|---|---|---|---|---|---|---|---|---|
| | 35,000 | 3,300 | 3,000 | 2,950 | 2,800 | 2,600 | 2,300 | 21,800 |
| Sauvignon blanc, | | | | | | | | |
| Wash State | | | | | | | | |
| Control | 100 | 100 | 100 | 100 | 100 | 100 | 0 | 100 |
| Protease | 10 | 25 | 0 | 30 | 50 | 200 | 0 | 20 |
| Papain | 100 | 100 | 100 | 100 | 100 | 100 | 0 | 100 |
| Chardonnay, Calif. | | | | | | | | |
| From concentrate | | | | | | | | |
| Control | 100 | 100 | 0 | 100 | 100 | 0 | 0 | 100 |
| Protease | 0 | 20 | 0 | 70 | 50 | 0 | 0 | 0 |
| Papain | 100 | 100 | 0 | 100 | 100 | 0 | 0 | 0 |
| Muscat of Alexandria | | | | | | | | |
| Central California | | | | | | | | |
| Control | 100 | 100 | 0 | 100 | 100 | 100 | 100 | 100 |
| Protease | 20 | 20 | 0 | 5 | 30 | 25 | 30 | 20 |
| Papain | 90 | 100 | 0 | 100 | 100 | 100 | 100 | 100 |

A comparison of the SDS-PAGE protein profiles in Table 4 to the corresponding grape varieties in Table 3, reveals that the reduction of protein bands (or concentration) in the molecular weight range of 21,800-35,000 Dalton by protease decreases in beat-induced precipitate. As explained above, most wine researchers found wine proteins in the molecular weight range of 20,000-30,000 Dalton are responsible for heat-induced protein precipitation. However, when the wine samples are heated under the same condition as the heat test, no protein bands appear in the SDS-PAGE analysis.

The results in this Example provide strong supporting data that protease can indeed hydrolyze the heat-unstable proteins when used under the standard winemaking conditions prescribed above.

### EXAMPLE 5

As stated above, protease is a protein in nature and it will form haze or precipitate at elevated temperatures. The amount of haze or precipitate depends on the protease concentration or dosage used. One must balance the effective dosage vs. the avoidance of haze or precipitate formation.

This example demonstrates that after grape protein is hydrolyzed, enzyme protein in protease will contribute to heat-induced protein precipitate in the same way as the grape protein. Sauvignon blanc juice was reconstituted from concentrate to 20° Brix. Samples of the Sauvignon blanc juice were prepared by adding thereto protease in at levels of 0, 180, 540 and 900 mg/L. The samples were then fermented as described above.

Protease dosages at all levels were effective in controlling foam during fermentation. After all the sugars were converted to alcohol, the wine was clarified with 60 mg/L gelatin and 2.6 ml/L colloidal silica. The clear wine samples were then subjected to a heat test in which the samples were heated at 60° C. for 15 hours and then cooled to 21° C. The results of the heat tests are presented in Table 5.

TABLE 5
Heat-induced protein precipitate from high dosages of Protease

| Enzymes dosage | Heat-induced haze | Heat-induced precipitate |
|---|---|---|
| Control, no Protease | +++ | +++++ |
| Protease, 180 mg/L | +++ | -0- |
| Protease, 540 mg/L | ++ | ++ |
| Protease, 900 mg/L | ++ | +++ |

From the results displayed in Table 5 it is obvious that the use of protease at 180 mg/L effectively removed all the heat-unstable grape proteins and at the same time did not cause heat-induced protein precipitate. Protease at higher dosages than 180 mg/L did contribute to precipitate.

### EXAMPLE 6

Examples 1-4 provide unequivocal data that supports the discovery that by using a protease that has sufficient activity at the fruit acidic environment, it is possible to effectively eliminate heat-induced precipitate from the fruit protein. At the same time, an effective enzyme dosage can be used to avoid the formation of precipitate, but not the haze, from the protein component in protease.

This Example investigates the amount of bentonite that must be used to eliminate all the protein haze or precipitate in wines treated with or without protease.

In this Example, control samples of Sauvignon blanc wine, which had been previously clarified with gelatin at 60 mg/L and colloidal silica at 2.6 ml/L were used. 60 mg/L gelatin were added to the control samples together with amounts of 360, 720, 1080, and 1440 mg/L bentonite.

Additional samples of Sauvignon blanc wine, which were treated with 180 mg/L protease and clarified under the same condition as the control samples above were provided. 60 mg/L gelatin was added to these additional samples together with 120 mg/L and 180 mg/L bentonite.

Further samples which did not include bentonite were prepared from the control samples. After two days of settling, the bentonite-treated samples were filtered and subject to a heat test in which the samples were heated at 60° C. for 15 hours and then cooled to 21° C. The results of the heat tests are presented in Table 6.

TABLE 6
Amount of bentonite needed to reduce the wine protein to the
same level as the protease-treated Sauvignon blanc

| | | Heat-induced |
|---|---|---|
| | Heat-induced haze | precipitate |
| Control, no bentonite | +++ | +++++ |
| Protease-treated, 180 mg/L | | |
| (1) No bentonite | +++ | -0- |
| (2) Bentonite-treated, 120 mg/L | + | -0- |
| (3) Bentonite-treated, 180 mg/L | -0- | -0- |
| Bentonite-treated | | |
| (1) 360 mg/L | ++ | +++ |
| (2) 720 mg/L | + | + |
| (3) 1080 mg/L | -0- | -0- |
| (4) 1440 mg/L | -0- | -0- |

The data in Table 6, shows that it takes 1080 mg/L bentonite to adsorb all the grape protein in the control wine, and it takes 180 mg/L bentonite to adsorb the heat haze-forming protease protein, to render all the wines free from any heat haze or precipitate. That means, the use of protease in wine can effectively replace 900 mg/L or 83% bentonite (a difference between 1080 and 180 mg/L).

### EXAMPLE 7

From the initial work conducted during the course of the present invention, the inventors observed that protease is more effective in hydrolyzing heat-unstable grape protein in juice than in wine. In this Example samples were test to confirm that, as wine components are being generated at different stages of fermentation, the protease becomes less effective.

In order to observe and investigate the inhibitory effects by wine components and to avoid the over-powering effect with high protease dosages, two low dosages of protease at 30 and 90 mg/L were tested in this Example. Same length of contact time and approximately the same temperature were allowed for the enzyme in all samples. The samples were clarified with 60 mg gelatin and 2.6 ml per liter colloidal silica and filtered with a 0.45 micron membrane and subjected to a heat test in which the samples were heated at 60° C. for 15 hours and then cooled to 21° C. The samples used in this Example were prepared as follows:

1) Protease added at beginning of fermentation, 20° Brix:

Control-no enzyme

Protease, 30 mg/L

Protease, 90 mg/L

2) Protease added to half-fermented juice, approx 10° Brix:

Control-no enzyme

Protease, 30 mg/L

Protease, 90 mg/L

3) Protease added when fermentation is complete, 0° Brix:

Control-no enzyme

Protease, 30 mg/L

Protease, 90 mg/L

The results of heat-induced haze and heat-induced precipitate at the beginning, mid-point and end of the fermentation stage are presented in Table 7.

TABLE 7
Effect of wine components on protease activity

| Enzyme | Fermentation stage | | | | | |
|---|---|---|---|---|---|---|
| dosage | Beginning | | Half-way | | Completion | |
| Mg/L | at ppt | Heat haze | heat ppt | heat haze | heat ppt | Heat haze |
| Control | +++ | +++ | +++ | +++ | +++ | +++ |
| 30 mg/L | +++ | ++ | +++ | +++ | +++ | +++ |
| 90 mg/L | + | ++ | +++ | +++ | +++ | +++ |

As observed from the results in Table 7, protease dosages at 30 and 90 mg/L were not sufficient to remove all the heat-induced protein precipitate. However, the data in Table 7 definitely demonstrates that protease is most effective when added at the beginning of fermentation, before the generation of wine components. In another experiment (data not shown) it was found that normal concentration of alcohol in wine, e.g. up to 15% v/v, and sulfur dioxide, e.g. up to 250 mg/L, are not inhibitory.

The above results reveal an important finding—by using protease before the generation of wine components, the inhibitory effect can be avoided and the enzyme is allowed to exercise its full activity on grape protein.

### EXAMPLE8

During the course of the present invention it has been discovered that juice treated with protease did not produce a significant amount of foam during fermentation. As explained above, the heat-unstable protein may well be the cause of foaming problems. This Example is designed specifically to demonstrate that removing heat-unstable protein will reduce the foaming problem.

It is known that the level of foam in a fermenter is directly proportional to the amount of surface active material such as protein and the ratio of volume to surface area of the fermenting vessel. Since Sauvignon blanc has the highest amount of protein among all the varieties of wines tested, it was chosen for testing in this Example. A fermenter having a diameter to height ratio of 1:2.75 was used in this example. This diameter to height ratio falls within the normal range of industrial wine fermenters which is between about 1:2 and 1:3.

In this Example, three 500 ml samples of Sauvignon juice from concentrate were fermented each in a 1 L graduated cylinder at about 20° C. The samples were prepared as follows:

1) Control with no enzyme

2) Protease, 540 mg/L

3) Papain, 540 mg/L

The level of foam was recorded during fermentation. Table 8 shows the percent foam volume generated in each fermenter.

TABLE 8
Anti-foam effect of Protease on fermentation

% Foam volume in fermenter at
different fermentation times (hours)

| Treatment | 8 | 18 | 24 | 48 |
|---|---|---|---|---|
| Control, no enzyme | -0- | 30 | 40 | -0- |
| Protease | -0- | -0- | -0- | -0- |
| Papain | -0- | 30 | 35 | -0- |

Both the control and papain fermenters had 30-40% volume of foam above the liquid level after 24 hrs of fermentation, indicating that the carbon dioxide generated causes the foaming. The fermenter containing the protease sample did not produce any foam at all during the entire fermentation period. It is unlikely that the foaming is due to the presence of polysaccharides such as pectin, because the juice used had been treated with a commercial pectinase, which also contains other enzymes such as arabanase to eliminate most, if not all, of the polysaccharides in juice.

To confirm the above discovery, further experiments were designed and conducted to study the dose response of the protease, and assure that there was no non-enzymatic anti-foam effect in the enzyme preparation by using heat-inactivated protease.

The following fermenters are set up to address these additional issues, again, using 500 ml samples of the Sauvignon blanc juice from concentrate in a 1 L cylinder:

1) Control, no enzyme

2) Heat inactivated Protease, 540 mg/L

3) Protease, 180 mg/L

4) Protease, 540 mg/L

5) Protease, 900 mg/L

6) Papain, 540 mg/L

In this experiment the fermenters were aerated immediately after completion of fermentation, or when all the sugars were fermented, in order to simulate the effect of movement or transfer of newly fermented wine in a situation in which foaming could cause production problems. The aeration rate was 60 cc/min for 30 seconds, and the foam levels and decay times are listed in Table 9.

TABLE 9
Anti-foam effect of Protease on the foamability of
newly fermented wine

| | | Foam decay |
|---|---|---|
| Treatment | % Foam volume | time (seconds) |
| Control, no enzyme | 100 | 71 |
| Heat-inactivated Protease, 540 mg/L | 100 | 50 |
| Papain, 540 mg/L | 100 | 60 |
| Protease, 180 mg/L | 44 | 5 |
| Protease, 540 mg/L | 46 | 5 |
| Protease, 900 mg/L | 64 | 7 |

As it can be seen from the results in Table 9, protease at all levels generated less foam than the control, heat-inactivated protease, and papain. It is important to note that the anti-foam action is entirely due to the protease action, and not any non-enzymatic effect, as the heat-inactivated protease did not show any anti-foam activity. It is also interesting to note that the protein in protease itself also causes some foam, if a higher level, e.g. 900 mg/L, is used. This observation further supports the assumption that foaming problems in wine fermentation are due largely to the presence of protein, whether it is from the grape itself or from other sources.

### EXAMPLE 9

This Example demonstrates that the foam-control ability of protease is attributable to its activity toward the protein that causes the foam problems, and also to demonstrate that the foam-control ability of protease is not influenced by other factors such as yeast action in fermentation.

In this Example, protease was added to Sauvignon blanc juice in a cylinder with a surface area to volume ratio of 1:2.5, and allowed to react at room temperature for 0, 1, 2, 3, and 5 hours. At the end of each incubation period, the juice was aerated at 60 cc/min for 30 seconds, and the resulting foam was allowed to subside. Both the foam volumes and the foam decay times were recorded and are presented in Table 10.

TABLE 10
Foamability of Sauvignon blanc juice treated with protease
at different incubation times

| | |
|---|---|
| | Foam decay |
| % Foam volume | time (seconds) |

| Incubation | 0 | 1 | 2 | 3 | 5 | 0 | 1 | 2 | 3 | 5 |
|---|---|---|---|---|---|---|---|---|---|---|
| time (hrs.) | | | | | | | | | | |
| Control, | 120 | 110 | 110 | 110 | 120 | 69 | 52 | 53 | 55 | 51 |
| no enzyme | | | | | | | | | | |
| Heat- | 120 | 110 | 120 | 120 | 110 | 60 | 53 | 53 | 60 | 52 |
| inactivated | | | | | | | | | | |
| Protease | | | | | | | | | | |
| Papain | 120 | 120 | 130 | 130 | 120 | 60 | 56 | 68 | 69 | 53 |
| Protease, | 120 | 50 | 94 | 90 | 110 | 51 | 23 | 35 | 30 | 35 |
| 180 mg/L | | | | | | | | | | |
| Protease, | 120 | 88 | 120 | 100 | 104 | 50 | 29 | 35 | 30 | 33 |
| 540 mg/L | | | | | | | | | | |
| Protease, | 130 | 94 | 110 | 120 | 110 | 57 | 29 | 35 | 33 | 33 |
| 900 mg/L | | | | | | | | | | |

As can be seen from the data in Table 10, there is insignificant difference in foam levels and foam decay times between the control, heat-inactivated protease, and papain treated juice. This Example demonstrates that as little as 180 mg/L protease is sufficient to control the foam in one hour of incubation at room temperature. This is quite important in production, because one would want a fast acting protease to control the formation of foam as early as possible during the production stage.

The increase in foam level with time in the protease treated juices indicate that other foam contributing factors, such as onset of fermentation, sugar and polymeric carbohydrates in grape juice, start to affect the foam level. The constant foam decay time, which are found to be independent of length of incubation, indicate that protease has already eliminated the foam-causing grape protein.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A method of rendering wine heat-stable which comprises:
providing a fermentable material which is subsequently processed to produce wine; and
adding to at least one of the fermentable material or wine produced therefrom, prior to bottling the wine, a protease that will hydrolyze proteins that cause heat-induced protein haze or precipitate.

2. A method of rendering wine heat-stable according to claim 1, wherein the protease is added to the wine.

3. A method of rendering wine heat-stable according to claim 1, wherein the protease is added to the fermentable material.

4. A method of rendering wine heat-stable according to claim 1, wherein the protease is derived from at least one of microbial sources, plants, and animals and is active over a pH range of from about 2.5 to about 4.0.

5. A method of rendering wine heat-stable according to claim 1, wherein the protease is added in an amount of from about 30 to about 900 mg per liter.

6. A method of rendering wine heat-stable according to claim 5, wherein the protease is added in an amount of from about 120 to about 540 mg per liter.

7. A method of rendering wine heat-stable according to claim 1, wherein the protease hydrolyzes proteins that cause heat-induced protein haze or precipitate above about 30° C.

8. A method of rendering wine heat-stable according to claim 7, wherein the protease hydrolyzes proteins that cause heat-induced protein haze or precipitate above about 60° C.

9. A method of producing an alcohol beverage which comprises the steps of:
a) providing a fermentable fruit material;
b) fermenting the fermentable fruit material under conditions sufficient to produce an alcohol beverage; and
c) adding protease to at least one of the fermentable fruit material before fermentation and the alcohol beverage after fermentation to hydrolyze proteins that cause heat-induced protein haze or precipitate.

10. A method of producing an alcohol beverage according to claim 9, wherein the protease is added to the fermentable fruit material before or during fermentation to hydrolyze proteins that cause heat-induced protein haze or precipitate and to control foaming.

11. A method of producing an alcohol beverage according to claim 9, wherein the fermentable fruit material comprises at least one of grapes, apples, pineapples, peaches, pears, oranges, grapefruit, and berries.

12. A method of producing an alcohol beverage according to claim 9, wherein the protease is derived from microbial sources, plants, and/or animals, and is active at a pH of the fermentable material.

13. A method of producing an alcohol beverage according to claim 12, wherein the protease is derived from Aspergillus niger.

14. A method of producing an alcohol beverage according to claim 9, wherein the protease is added to the fermentable fruit material in an amount of from a bout 30 to about 900 mg per liter.

15. A method of producing an alcohol beverage according to claim 9, wherein the protease hydrolyzes proteins that cause heat-induced protein haze or precipitate above about 30° C.

16. A method of producing an alcohol beverage according to claim 15, wherein the protease hydrolyzes proteins that cause heat-induced protein haze or precipitate above about 60° C.

17. A method of controlling foaming in a fermentation process which comprises the steps of:
a) providing a fermentable material;
b) fermenting the fermentable material under conditions sufficient to normally produce foam; and
c) adding protease to the fermentable material before fermentation to control the production of foam.

18. A method of controlling foaming in a fermentation process according to claim 17, wherein the fermentable material comprises at least one of grapes, apples, pineapples, peaches, pears, oranges, grapefruit, and berries.

19. A method of controlling foaming in a fermentation process according to claim 17, wherein the fermentation produces at least one of beverages, enzymes, foods, feed ingredients, food supplements, pharmaceuticals, and bio-active materials.

20. A method of controlling foaming in a fermentation process according to claim 17, wherein the fermentable material is transferred and the protease prevents foaming of the fermentable material while it is being transferred.

21. A method of making wine which comprises the steps of:
a) providing a fermentable fruit material;
b) fermenting the fermentable fruit material under conditions sufficient to produce an alcohol beverage;
c) removing solids from the fermented fermentable material; and
d) adding protease to at least one of the fermentable fruit material before or during fermentation and the alcohol beverage after fermentation to hydrolyze proteins that cause heat-induced protein haze or precipitate.

22. A method of making wine according to claim 21, wherein the protease is added to the fermentable fruit material before or during fermentation to hydrolyze proteins that cause heat-induced protein haze or precipitate and to control foaming.

23. A method of making wine according to claim 21, wherein the protease is added to the fermentable fruit material before step c).

24. A method of making wine according to claim 21, wherein the protease is added in an amount of from about 30 to about 900 mg per liter.

25. A method of making wine according to claim 21, wherein the protease hydrolyzes proteins that cause heat-induced protein haze or precipitate above about 30° C.

26. A method of rendering wine heat-stable according to claim 25, wherein the protease hydrolyzes proteins that cause heat-induced protein haze or precipitate above about 60° C.

27. In a winemaking process which includes the use of bentonite to adsorb the heat-unstable proteins, the improvement comprising substituting at least a portion of the bentonite with a protease that hydrolyzes the heat-unstable proteins.

28. The winemaking process of claim 27, wherein the portion of bentonite that is substituted by the protease comprises about 50 to 90% of the bentonite.

29. The winemaking process of claim 27, wherein the portion of bentonite that is substituted by the protease comprises about 80 to 85% of the bentonite.

30. The winemaking process of claim 27, wherein the portion of bentonite that is substituted by the protease comprises at least about 30% of the bentonite.

31. The winemaking process of claim 27, wherein the protease hydrolyzes proteins that cause heat-induced protein haze or precipitate above about 30° C.

31. The winemaking process of claim 27, wherein the protease hydrolyzes proteins that cause heat-induced protein haze or precipitate above about 30° C.

32. The winemaking process of claim 31, wherein the protease hydrolyzes proteins that cause heat-induced protein haze or precipitate above about 60° C.

33. A method of controlling foaming during the processing of a liquid fruit material which comprises the steps of:
a) providing a liquid fruit material that is subjected to processing step that normally causes foaming of the liquid fruit material; and
b) adding protease to the fruit material fermentation to control the production of foam during the processing.

34. A method of controlling foaming during the processing of a liquid fruit material according to claim 33, wherein the liquid fruit material comprises at least one of a juice or juice concentrate.

35. A method of controlling foaming during the processing of a liquid fruit material according to claim 33, wherein the liquid fruit material is subjected to a fermentation process.
